(19) United States
(12) Patent Application Publication
(10) Pub. No.: US 2002/0163516 A1
(43) Pub. Date: Nov. 7, 2002

(54) Method and system for presenting objects having see-through surfaces in a computer graphics system

(76) Inventor: Kenneth R. Hubbell, Raleigh, NC (US)

Correspondence Address: HAYNES AND BOONE, LLP, 901 MAIN STREET, SUITE 3100, DALLAS, TX, 75202, US

(21) Appl. No.: 09/846,511

(22) Filed: May 1, 2001

(51) Int. Cl. G06T 15/50; G06T 15/60; G09G 5/02

(52) U.S. Cl. 345/426; 345/592

(57) ABSTRACT

A method is provided for generating a full featured object having one or more see-through surfaces in a computer graphics scene. The object has one or more exterior surfaces which are visible without being viewed through the see-through surfaces, and interior surfaces which are only visible through the see-through surfaces. A first mesh system is provided having a plurality of vertices for defining a first layer of each surface, and a second mesh system is also provided for defining a second layer of the surface located virtually underneath the first layer, the second mesh system correlating to the vertices of the first mesh system. One or more material attributes are associated with each vertex in each mesh system, and the material attributes are adjusted to present the exterior surfaces and interior surfaces so that a realistic presentation of the object is shown.

### BACKGROUND OF THE INVENTION

The present invention relates generally to computer graphics display systems, and more particularly, to a system and method for presenting gemstones or other objects having see-through surfaces in a computer graphics scene.

A computer-based graphics processing system represents and renders three-dimensional objects for display on a two-dimensional display device. The system normally includes computers, display devices, input devices and other necessary hardware and software for processing and displaying computer graphics. For example, in some applications, animated scenes are depicted where objects and characters move around within the scene as they are controlled by an input device such as a mouse, a joystick, or a keyboard. An objective of such a system is to display graphics scenes as realistically as possible and allow a user of the system to interact with various components of the scenes.

As it is well known in the industry, computer graphics scenes are typically designed by graphics designers using computerized tools to construct and place objects within a scene. In most cases, objects may be created once and then saved in a library of objects for multiple uses later. These saved objects may be retrieved and placed along with other newly created objects in any scene.

Computer graphics scenes are typically generated in two phases. In the first phase, a graphics designer composes the scene using special-purpose software and a graphics processing computer system. A scene is built by adding objects and characters thereto and giving the objects and characters predefined characteristics appropriate for their appearances in the scene. The characteristics are normally defined by material attributes. The material attributes for an object normally include size, color, texture, and information indicating whether the agent is fixed in location or movable.

In the second phase, the scene can be animated and may be run independently or in response to commands of viewing users entered through input devices to control the movements of the objects or characters within the scene.

In constructing graphics scenes, objects and characters may have “surfaces.” The surfaces are conventionally represented as a “mesh” system of points or vertices, which are connected to form polygons covering the object or character's exterior. Textured patterns are applied to the polygons to give them the desired appearance. For example, a wall in a computer graphics scene may need to be shown as wood, brick, or covered by ivy depending on the color and texture applied to the corresponding polygons. The mesh system thus gives graphics designers a great deal of freedom in manipulating appearances of various components in the graphics scene.

In addition to a texture, a surface may also be affected by other material characteristics controllable by material factors. The material factors are traditionally classified as “ambient”, “spectral”, and “opacity” factors. For example, the ambient factor defines a self-lighting effect at a particular vertex. The spectral factor defines how the light shininess would affect the color of the vertex based on a viewing angle and a light source (in view of its direction, color, intensity, etc.) found in the scene. And the opacity factor (or the see-through factor) determines how transparent a particular area around a vertex is, etc. A see-through surface refers to any surface that is not opaque. The see-through surface can further be classified as fully transparent or translucent depending on the transparency level thereof. In a normal situation, an opaque surface has its opacity factor set at a first predetermined value, while a fully transparent surface has its opacity factor set at a second predetermined value. A translucent see-through surface has its the opacity factor set at an intermediate value. With these attributes or factors, a particular polygon's color and texture may be modified by other objects, light source, viewing angle, etc. In essence, the combination of the texture configuration and material factors give a polygon its final presentation.

It is more difficult to render a realistic appearance of an object if it has one or more see-through surfaces, due to the light refraction and reflection on various surfaces. The translucency or transparency of the see-through surfaces of an object allows light to travel through certain surfaces depending on the clarity and color of the see-through surfaces and the color/texture of surfaces “interior” to the see-through surfaces.

A typical object having see-through surfaces is a piece of gemstone. Gemstones have a multitude of see-through and reflective surfaces such that if the light refraction and reflection are considered and mathematically simulated and calculated, it would require a substantially large amount of computer processing resource, which is impractical given today's state-of-art computer graphics systems. The transparency of the see-through surfaces of a piece of gemstone allows light to travel through the gemstone in various intensities and colors depending on the clarity and color of the gemstone. In addition, depending on how the gemstone is cut and the refraction index of the gemstone, the light color may be altered as it enters the gemstone. This creates the “rainbow” effect seen in diamonds and other gems.

Simulating the interior of a gemstone is thus difficult due to a combination of the “rainbow” effect, spectral highlighting, and reflective surfaces on both the inside and outside of the gemstone.

What is needed is an efficient method for creating a realistic appearance of an object having one or more see-through surfaces in a computer graphics scene.

### SUMMARY OF THE INVENTION

A method is provided for generating a full featured object having one or more see-through surfaces in a computer graphics scene. The object has one or more exterior surfaces which are visible without being viewed through the see-through surfaces, and interior surfaces which are only visible through the see-through surfaces. A first mesh system is provided having a plurality of vertices for defining a first layer of each surface, and a second mesh system is also provided for defining a second layer of the surface located virtually underneath the first layer, the second mesh system correlating to the vertices of the first mesh system. One or more material attributes are associated with each vertex in each mesh system, and the material attributes are adjusted to present the exterior surfaces and interior surfaces so that a realistic presentation of the object is shown.

In one example of the present invention, a realistic appearance of gemstones is presented without incurring actual calculations for light refraction and reflection. Two mesh systems are used for each surface of the gemstone, one for the first layer of the surface, and one for the second layer of the surface. The two mesh systems have exactly the same mesh vertex coordinates. Two independent sets of material attributes are assigned to each vertex, one is used for the first layer and one for the second layer. The material attributes are adjusted in a predetermined manner depending on whether the vertex is part of an exterior surface or an interior surface of the gemstone and whether the surface is opaque or not. Taking a clear diamond as an example, to simulate refraction, a color on the first layer for the exterior surfaces is set to white or red and the color of the second layer is set to blue or cyan along with adjustments made to a spectral factor.

### BRIEF DESCRIPTION OF THE DRAWINGS

FIG. 1 illustrates a simple object having one or more see-through surfaces.

FIGS. 2-3, and 5-6 illustrate views of a gemstone in a graphics scene according to one example of the present invention.

FIG. 4 is a flow diagram illustrating processing steps for simulating different surfaces of the gemstone.

FIG. 7 illustrates a computer system that implements examples of the present invention.

### DESCRIPTION OF THE PREFERRED EMBODIMENT

In a mesh system for objects in the computer graphics scene, the vertices and information contained in or related to them are the essential elements for creating a desired appearance of the graphics scene. In such a mesh system, the conventional horizontal, plenary, and vertical axis system, i.e., [x, y, z], is normally used. Each vertex has a position in space as defined by a space value set [x, y, z]. Furthermore, each vertex has a color value associated with it in a color value set, e.g., [r, g, b], each parameter representing a red, green, and blue color value respectively.

In addition, various other material attributes are related to each vertex. For example, an attribute called ambient factor defines a self-lighting effect at a particular vertex, a spectral factor defines how the light shininess would affect the color of the vertex based on a viewing angle and a light source found in the scene, and an opacity factor (or the see-through factor) determines how transparent a particular area around a vertex is, etc. These material factors may be further stored as parameters in a material value set such as [a, s, o], with “a” representing the ambient factor, “s” representing the spectral factor, and “o” representing the opacity factor. The number of parameters in the material value set can be expanded depending on the number of attributes needed for a particular application and the complexity of the computer graphics programming. In general, the more parameters included, the more sophisticated the design of the graphic scene will be. Other material characteristics such as diffuse color and level, and reflectivity are commonly contemplated. For illustration purposes, only the [a, s, o] attributes are shown here.

Referring to FIG. 1, a cubic object 10 has see-through surfaces defined by two layers of meshes according to one example of the present invention. For illustrating the concept of this example of the present invention, the top surface 12 and the bottom surface 14 are all shown as being constructed by two layers of meshes, one exterior layer for the physical surface defining the object, and one interior layer for a virtual surface located immediately interior to the exterior layer. It is understood that each surface of an object is constructed similarly using this two-layer structure if necessary. The term “see-through surface” generally refers to any surface that has different degrees of transparency. Further, the term “exterior surface” indicates that the surface is visible without being viewed through any see-through surface, and the term “interior surface” means a surface that is only visible through one or more see-through surfaces.

For illustration purposes, in FIG. 1, the top surface of the cubic object 10 is clearly dissected into two layers, one defined by vertices a-b-c-d with solid lines connecting among them, and one defined by vertices a′-b′-c′-d′ with ghost lines connecting among them. However, it is understood, although it does not appear so, that the vertices “a,” “b,” “c,” and “d” are vertices “a′,” “b′,” “c′,” and “d′,” respectively. Therefore the interior layer 12′ only exists as a virtual layer for the graphics design purpose while a user should not be able to distinguish the layers. By defining a surface with two layers of meshes, when a light source 16 external to the object is provided, a light beam is assumed to hit the exterior layer of the top surface 12 first, passes through the exterior layer and lands on the interior layer 12′, and further lands on an interior layer 14′ of the bottom surface and finally on the exterior layer 14 of the bottom surface. In other words, from a user's perspective, if it is assumed that the user (indicated by an eye symbol 18) can only see parts of the object that are illuminated by a light source, he/she then can see the interior layer of the bottom surface 14 through the top surface 12. In this example, the top surface 12 defined by vertices (a, b, c, d) is an exterior surface, while the bottom surface 14 is an interior surface.

Two sets of material attributes are assigned to each vertex point, one used with the exterior layer, and one with the interior layer. They are generally referred to as the exterior set and the interior set. The two-layer structure along with the two corresponding sets of material attributes gives ample control in graphics design, and thus allow a realistic depiction of any object having see-through surfaces.

One key feature of one example of the present invention is to use a combination of color and spectral factor adjustment in both the exterior and interior layers to simulate the appearance of the surfaces with the consideration of all light refraction and reflection. For instance, the spectral factor of the exterior set is programmed to be a first predetermined color (such as white or red), and the color of spectral factor of the interior set is set to another predetermined color (such as blue or cyan) depending on the color of the object as the designer sees it. Further, the appearance of any surface is affected by the opacity of itself or the opacity of at least one surface related thereto. For instance, in FIG. 1, the appearance of the bottom surface 14 is affected by the opacity of the top surface 12. The opacity of a surface such as the top surface 12 is also determined by a viewing angle (such as α) and an incidental angle of the ambient light (such as θ). The opacity of the top surface 12 as represented by opacity factors of both exterior and interior layers further determines how the interior and exterior sets should be blended to give a final appearance of the related surfaces.

One example of the objects having see-through surfaces in a computer graphics scene is a simulated gemstone such as a diamond. The diamond has its distinctive cut so that various transparent surface and edges between these surfaces, in aggregate, give an overall view of the diamond.

The shape of the diamond is defined by identifying the vertices of all the “corners” of the diamond and connecting the vertices by lines which define the boundaries of the surfaces. Each vertex of the diamond is given three sets of coordinates/parameters representing location, color and other material aspects of the vertex. The color parameters (e.g., [r, g, b]) typically have a number from 0 to 255 giving the relative intensity of the color component. Initially, the values can all be zero which makes the diamond appear all in white.

For the case of depicting diamonds, the material factors such as ambient, opacity, and spectral factors, each typically has a number from 0 to 255 giving, respectively, the degree of “self-lighting,” the degree of transparency (value 0-255) and the effect of highlighting (spectral shift value from −127 (red) to +127 (blue)). Initially, the values can all be set to zero as well. Once the vertices for the diamond are defined as above, an exact copy of the mesh is made. One mesh is used to represent the exterior layers of the diamond, while the other represents the interior layers.

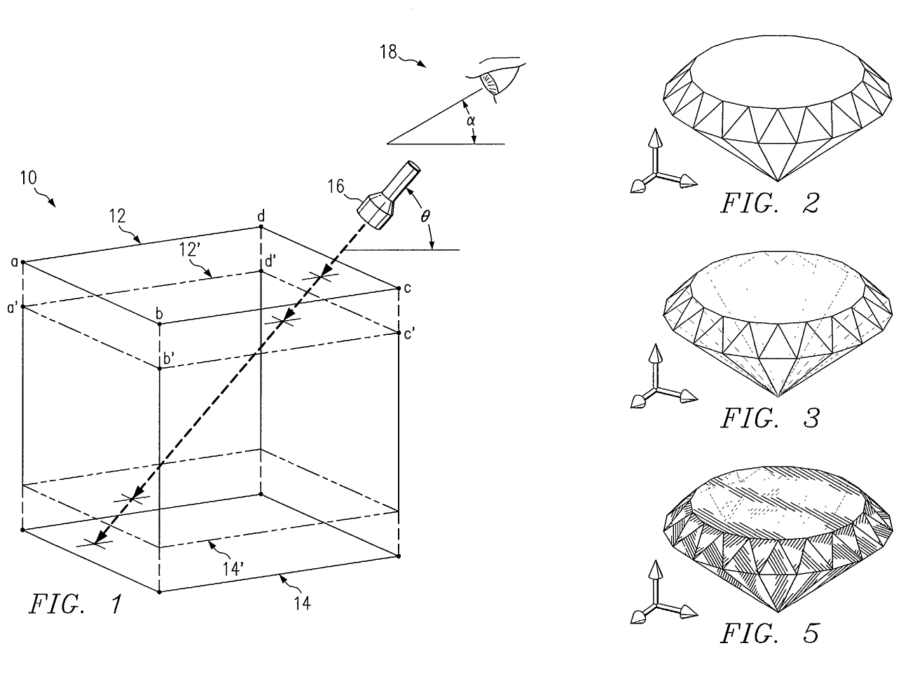

Referring to FIG. 2, a simulated diamond is shown with no visible interior surfaces. Due to a viewing angle, if it is expected that the interior space of the diamond is not visible through the exterior surfaces as the user sees it, the opacity factor of the exterior set on each surface is set to a predetermined extreme value (e.g., a high value) so that the exterior surfaces become non-transparent and none of the characteristics of the interior surfaces of the diamond affects the appearance of the exterior surfaces. In such a case, the graphics designers can simply define the color and the texture of the exterior surfaces of the diamond (such as white or red).

Referring to FIG. 3, the simulated diamond of FIG. 2 is shown with some of its exterior surfaces defined as see-through surfaces. In this case, the opacity factor is set to a predetermined value so that the interior surfaces (or more precisely, the textures of the interior layers) can be seen. Depending on the degree of transparency, which is adjustable by the value of the opacity factor, the color of the exterior layers of the exterior surfaces of the diamond are adjusted through a shift of spectral factors in the interior layers of the exterior surfaces and all visible surfaces underneath the exterior surfaces. For instance, top surfaces of the diamond may have their colors set as white, and if they are not opaque, the corresponding spectral factors may be adjusted to give special effect so that the diamond appears to give off a “blue glow.” More specifically, in this case, assuming the top surfaces are transparent, the spectral factors of the interior layers are set towards “blue,” (or mathematically, adding value to the “b” parameter in the [r, g, b] value set). Hence, the overall color of the diamond applied is shifted or highlighted in the blue direction. It is understood that this type of “highlighting” effect can be made for both the exterior surfaces and the interior surfaces. The color of these highlights are decided by the designer. For instance, in some cases, it is determined that for highlights on the exterior surfaces, “white” or “red” are used for diamonds, “white” or “blue” for emeralds, “yellow” or “white” for rubies, and “blue” or “white” for garnets. For interior surfaces, “red” or “cyan” are used for diamonds, “yellow” or “purple” for emeralds, “blue” or “green” for rubies, “red” or “blue” for garnets. The combined effect of highlighting with color and the design manipulation by the two-layer structure for each surface thus provide a tremendous advantage over any conventional methods to depict an object having see-through surfaces.

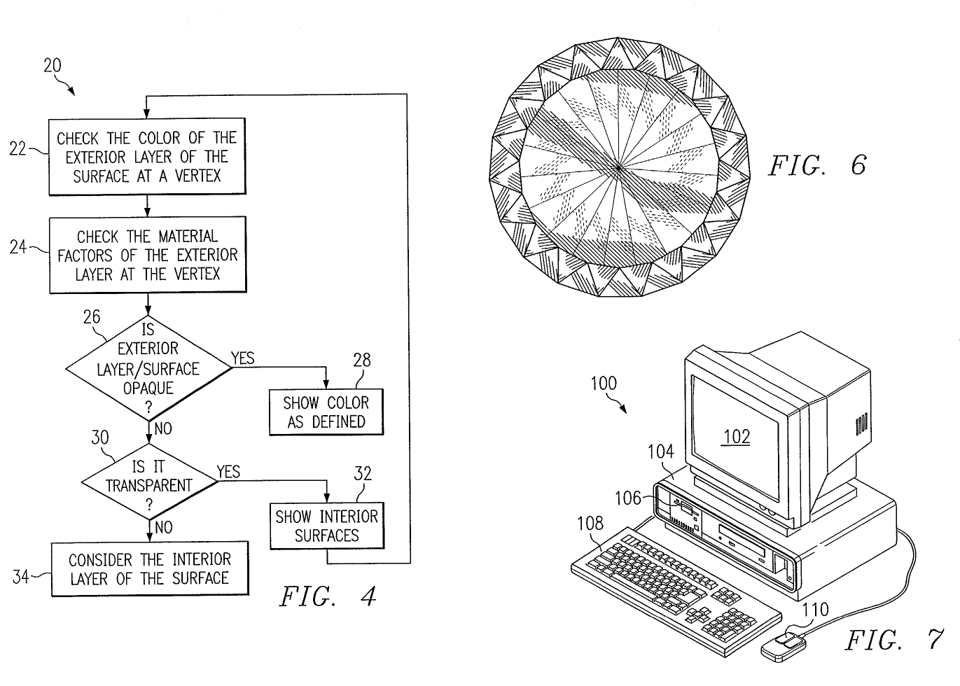

Referring to FIG. 4, a method 20 illustrates how an interior layer can be manipulated to affect the appearance of a surface according to one example of the present invention. When designing a surface, every single vertex is critical in that the color parameters and material factors together define the appearance of an area surrounding the vertex. Therefore, these areas collectively form a surface. In the following description, it is understood that whenever a surface is mentioned, it may mean an area surrounding a vertex. For example, in step 22, the color parameters or the values are identified for a vertex on the exterior layer of the surface. In step 24, the material factors such as [a, o, s] values are identified as well. It is understood that both the color parameters and the material factors combined determine the outcome of the texture of the surface. It is then determined whether the opacity factor indicates that the surface is an opaque in step 26. If so, this surface is not a see-through surface, and surfaces underneath or next to this surface will not affect the resultant appearance of this surface. Then the color as defined by the [r, g, b] values are used. If, in step 26, the opacity factor indicates that the surface is not an opaque one, it is determined whether it is fully transparent (step 30). If it is, the color as defined by the color sets is ignored and other surfaces that are seen through this surface are considered (step 32). Each other surface will be examined in the same way exhaustively starting from step 22. If in step 30, the surface is not fully transparent, it is translucent, the material factors and color parameters of the interior layer for the surface are considered to give effects such as the highlighting effect as described above.

For each surface, two sets of opacity factors and color sets are used—one for the exterior layer and the other for the interior layer. Processing the color or texture of the diamond takes into consideration of the colors of the exterior surfaces and those of the visible interior surfaces through the exterior surfaces if the exterior surfaces are not opaque. Conceptually, in a mathematical expression, the color of each surface can be more generally illustrated as follows:

Color=Op1×C1+Op2×C2,

wherein Op1 and Op2 denote the opacity factors of the exterior layer and the interior layer respectively, and C1 and C2 denote the colors or textures of the exterior layer and interior layer. In addition to the adjustment to the color and opacity factors, spectral shift is also made as described above.

Referring further to FIG. 5, full characteristics of the exterior and interior surfaces are shown in a diamond by different shading patterns. As illustrated above in FIG. 4, each surface of the diamond is processed according to the steps of the flow diagram in an exhaustive manner until an opaque surface such as a jewel box for seating the diamond is found (since the diamond is largely transparent from top down). For every surface, the designer can control the color as well as the material characteristics so that, in aggregate, the diamond shows the beauty of all cut surfaces. For example, if a first exterior surface is fully transparent or mostly transparent, the colors/textures of the interior surfaces are used, and a blue spectral shift may be added. On the other hand, if the exterior surface is opaque or barely-transparent, a shift in the red or white color can be used if the designer so desires. FIG. 6 is a close view of a portion of top surfaces of the diamond in FIG. 5 generated according to the example of the present invention described above.

In essence, the use of two layers of meshes defining the interior and exterior layers of each surface of an object having one or more see-through surfaces, combined with appropriate setting of the spectral and opacity factor values gives a realistic appearance of the object in a computer graphics system. And for presenting gemstones in particular, the use of this technique for both the exterior and interior surfaces allows for an efficient and realistic appearance.

Referring now to FIG. 7, a computer system 100 for implementing embodiments of the present invention is shown which includes a two-dimensional graphical display (also referred to as a “screen”) 102 and a central processing unit 104. The central processing unit 104 contains a microprocessor and random access memory for storing programs. A disk drive 106 for loading programs may also be provided. A keyboard 108 having a plurality of keys thereon is connected to the central processing unit 104, and an input device such as a mouse 110 is also connected to the central processing unit 104. It will also be understood by those having skill in the art that one or more (including all) of the elements/steps of the present invention may be implemented using software executed on general purpose computer systems or networked computer systems, using special purpose hardware-based computer systems, or using combinations of special purpose hardware and software.

The above disclosure may provide many different embodiments, or examples, for implementing different features of the invention. Specific examples of components and processes are described to help clarify the invention. These are, of course, merely examples and are not intended to limit the invention from that described in the claims.

While the invention has been particularly shown and described with reference to the preferred embodiment thereof, it will be understood by those skilled in the art that various changes in form and detail may be made therein without departing from the spirit and scope of the invention, as set forth in the following claims.

What is claimed is:

1. A method for generating a full featured object having at least one see-through surface in a computer graphics scene, the object having one or more exterior surfaces which are visible without being viewed through the see-through surface, and one or more interior surfaces which are only visible through the see-through surface, the method comprising:
providing a first mesh system having a plurality of vertices connected therebetween defining a first layer of each surface; and
providing a second mesh system defining a second layer of each surface located virtually next to the first layer, the second mesh system containing the same vertices of the first mesh system,
wherein one or more material attributes are associated with each vertex in both the first and second mesh systems, and
wherein the material attributes of both the first and second mesh systems are adjusted to present the exterior surfaces and interior surfaces so that a realistic presentation of the object is shown.

2. The method of claim 1 where in the material attributes includes a color factor, an ambient factor defining self-lighting effect, spectral factor defining a light shininess, and an opacity factor defining a transparency level of any surfaces.

3. The method of claim 2 wherein the transparency level includes fully transparent, translucent, and opaque.

4. The method of claim 3 wherein the spectral factor on the second layer of an exterior surface is adjusted if the opacity factor of the first layer indicates that the exterior surface is a translucent surface.

5. The method of claim 2 wherein both the color and spectral factors in the first and second layers are adjusted independently to render the full-featured presentation of the object.

6. The method of claim 2 wherein the color factors of both layers of the exterior and interior surfaces contribute to an overall color of the object.

7. A method for generating a full featured gemstone having at least one see-through surface in a computer graphics scene, the gemstone having one or more exterior surfaces which are visible without being viewed through the see-through surface, and one or more interior surfaces which are only visible through the see-through surface, the method comprising:
providing a first mesh system having a plurality of vertices defining an exterior layer of each surface;
providing a second mesh system defining an interior layer of each surface located virtually next to the exterior layer, the vertices of the second mesh system correlating to the same vertices of the first mesh system; and
adjusting one or more material attributes of both the first and second mesh systems to present the exterior surfaces and interior surfaces so that a realistic presentation of the object is shown,
wherein one or more material attributes are associated with each vertex in each mesh system.

8. The method of claim 7 wherein the material attributes include a color factor, an ambient factor defining self-lighting effect, spectral factor defining a light shininess, and an opacity factor defining a transparency level of each surface.

9. The method of claim 8 wherein the spectral factor on the interior layer of an exterior surface is adjusted toward a predetermined color if the corresponding exterior layer defines the exterior surface as a see-through surface.

10. The method of claim 8 wherein the color factors of both layers of the exterior and interior surfaces contribute to an overall color of the object.

11. A system for generating a full featured object having at least one see-through surface in a computer graphics scene, the object having one or more exterior surfaces which are visible without being viewed through the see-through surface, and one or more interior surfaces which are only visible through the see-through surface, the system comprising:
a first mesh system having a plurality of vertices defining a first layer of each surface; and
a second mesh system defining a second layer of each surface located virtually next to the first layer, the second mesh system containing the same vertices of the first mesh system,
wherein one or more material attributes are associated with each vertex in both the first and second mesh systems, and
wherein the material attributes of both the first and second mesh systems are adjusted to present the exterior surfaces and interior surfaces so that a realistic presentation of the object is shown.

12. The system of claim 11 where in the material attributes includes a color factor, an ambient factor defining self-lighting effect, spectral factor defining a light shininess, and an opacity factor defining a transparency level of the exterior surface.

13. The system of claim 13 wherein the spectral factor on the second layer of an exterior surface is set to a predetermined value along with an adjustment of the color factor if the opacity factor of the first layer indicates that the exterior surface is not an opaque surface.

14. The system of claim 12 wherein the color factors of both layers of the exterior and interior surfaces contribute to an overall color of the object.

15. A method for generating a full featured gemstone having at least one see-through surface in a computer graphics scene, the gemstone having one or more exterior surfaces which are visible without being viewed through the see-through surface, and one or more interior surfaces which are only visible through the see-through surface, the method comprising:
providing a two-layer mesh system having a plurality of vertices for each surface, a first layer defining an exterior layer and a second virtual layer defining an interior layer of the surface;
adjusting a color factor and a spectral factor of both the first and second layers depending on an expected transparency level of the surface;
repeating the step of adjusting until all surfaces of the gemstone are processed to render the full-featured appearance of the gemstone,
wherein color and spectral factors are associated with each vertex in each layer.
